(19) United States
(12) Patent Application Publication
(10) Pub. No.: US 2025/0356293 A1
(43) Pub. Date: Nov. 20, 2025

(54) PULL REQUEST RISK ASSESSMENT AND RISK REDUCTION

(71) Applicant: Microsoft Technology Licensing, LLC, Redmond, WA (US)

(72) Inventors: Shubham AGARWAL, Bengaluru (IN); Nishant KUMAR, Bengaluru (IN); Apoorv Prakash PATWARDHAN, Bengaluru (IN); Srikant Rao DHAIPHULE, Bengaluru (IN); Vinay GUPTA, Bengaluru (IN)

(21) Appl. No.: 18/665,514

(22) Filed: May 15, 2024

(51) Int. Cl. G06Q 10/0635; G06F 8/71

(52) U.S. Cl. CPC G06Q 10/0635; G06F 8/71

(57) ABSTRACT

Example solutions for pull request (PR) risk assessments and risk reductions are disclosed. Logical changes are identified within software code of a PR, code change noise is removed (e.g., formatting, comment, and white space changes) and risk scores are found for different risk categories (e.g., bug history, test coverage, PR comments). An aggregate risk score is determined, and a report is generated and distributed. The set of mandatory PR reviewers, from whom feedback is sought, is curated based on which files have logical changes, and in some examples, the degree of risk. For example, if a certain file has only non-logical changes, or only low-risk logical changes, then stakeholders of that file are designated as optional reviewers. This can significantly speed up PR approval, even while intelligently managing risks to the software code.

### BACKGROUND

Pull requests (PRs) are a common and widely used mechanism in software development, in which programmers propose changes to software code and request reviews and approvals from other programmers (i.e., reviewers) prior to merging the proposed changes into the main branch of the software code in a code repository. PRs are used to improve quality, reliability, and accessibility of the software code, by allowing the programmers to collaborate, communicate, and verify the proposed changes with other skilled programmers before potential errors are introduced into the main branch of the software code.

However, this practice introduces several challenges for the programmers and reviewers. PRs often contain a large number of changes, complicates the review process by increasing the difficulty of understanding, inspecting, and evaluating the changes in a timely and accurate manner. PRs often contain changes that are not logical or functional, but instead may be cosmetic or stylistic, such as formatting, renaming, refactoring, comments, or whitespace changes. Such changes do not change the underlying logic and functional results, but may add distraction for reviewers, reducing the focus and attention of the reviewers on the changes that do matter. In contrast, a logical change in a PR is one that affects the functionality, behavior, performance, or correctness of the code, and not just its style, appearance, structure, format, or documentation (e.g., comments).

PRs may contain changes that introduce risk, such as changes that may introduce or worsen bugs, errors, vulnerabilities, or code smells, or changes that ignore or contradict best practices, standards, or guidelines, and which compromise the quality, reliability, and accessibility of the code. Such changes typically require more attention and testing from the reviewers. PRs often require the involvement and approval of multiple reviewer groups, such as owners, experts, and stakeholders, which increases the complexity of and time required for the PR review process, and increases the likelihood of conflicts or inconsistencies among reviewer groups.

### SUMMARY

The disclosed examples are described in detail below with reference to the accompanying drawing figures listed below. The following summary is provided to illustrate some examples disclosed herein.

Example solutions for pull request (PR) risk assessments and risk reductions include: identifying, within software code of a PR, a set of logical changes; identifying, within the set of logical changes, code change noise; removing, from the set of logical changes, the code change noise; determining a PR aggregate risk score for the set of logical changes; generating a risk reduction report indicating the PR aggregate risk score, natural language explanations for factors affecting the PR aggregate risk score, and risk reduction actions; transmitting the risk reduction report across a computer network to at least a portion of a set of PR reviewers; altering the software code of the PR in accordance with the risk reduction actions identified within the risk reduction report; and based on at least altering the software code of the PR in accordance with the risk reduction actions, merging the software code of the PR into a software code project.

### BRIEF DESCRIPTION OF THE DRAWINGS

The disclosed examples are described in detail below with reference to the accompanying drawing figures listed below:

FIG. 1 illustrates an example architecture that advantageously provides pull request (PR) risk assessments and risk reductions;

FIG. 2 illustrates an exemplary PR, as may be used in examples of the architecture of FIG. 1;

FIG. 3 illustrates an exemplary logical change identifier, as may be used in examples of the architecture of FIG. 1;

FIG. 4 illustrates an exemplary code change noise detector, as may be used in examples of the architecture of FIG. 1;

FIG. 5 illustrates an exemplary risk assessor, as may be used in examples of the architecture of FIG. 1;

FIG. 6 illustrates an exemplary risk reduction report, as may be generated by examples of the architecture of FIG. 1;

FIG. 7 illustrates an exemplary training arrangement for training components of the architecture of FIG. 1;

FIGS. 8 and 9 show flowcharts illustrating exemplary operations that may be performed when using example architectures, such as the architecture of FIG. 1; and

FIG. 10 shows a block diagram of an example computing device suitable for implementing some of the various examples disclosed herein.

Corresponding reference characters indicate corresponding parts throughout the drawings.

### DETAILED DESCRIPTION

Example solutions for pull request (PR) risk assessments and risk reductions are disclosed. Logical changes are identified within software code of a PR, code change noise is removed (e.g., formatting, comment, and white space changes) and risk scores are found for different risk categories (e.g., bug history, test coverage, PR comments). An aggregate risk score is determined, and a report is generated and distributed. The set of mandatory PR reviewers, from whom feedback is sought, is curated based on which files have logical changes, and in some examples, the degree of risk. For example, if a certain file has only non-logical changes, or only low-risk logical changes, then stakeholders of that file are designated as optional reviewers. This can significantly speed up PR approval, even while intelligently managing risks to the software code. Further, experienced programmers, who may have previously been distracted from authoring new software code to participate in a PR, may be released from that distraction by being made optional when there are no logical changes involved in the PR that genuinely need attention from those programmers.

Aspects of the disclosure solve multiple problems that are necessarily rooted in computer technology and render computing platforms, which rely on software for proper functioning, more reliable and easier to use, by providing the practical result of reducing risks of software errors (e.g., bugs) while making software updates faster and less burdensome. This is accomplished, at least in part by, generating a risk reduction report indicating a PR aggregate risk score, natural language explanations for the factors affecting the PR aggregate risk score, and risk reduction actions.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

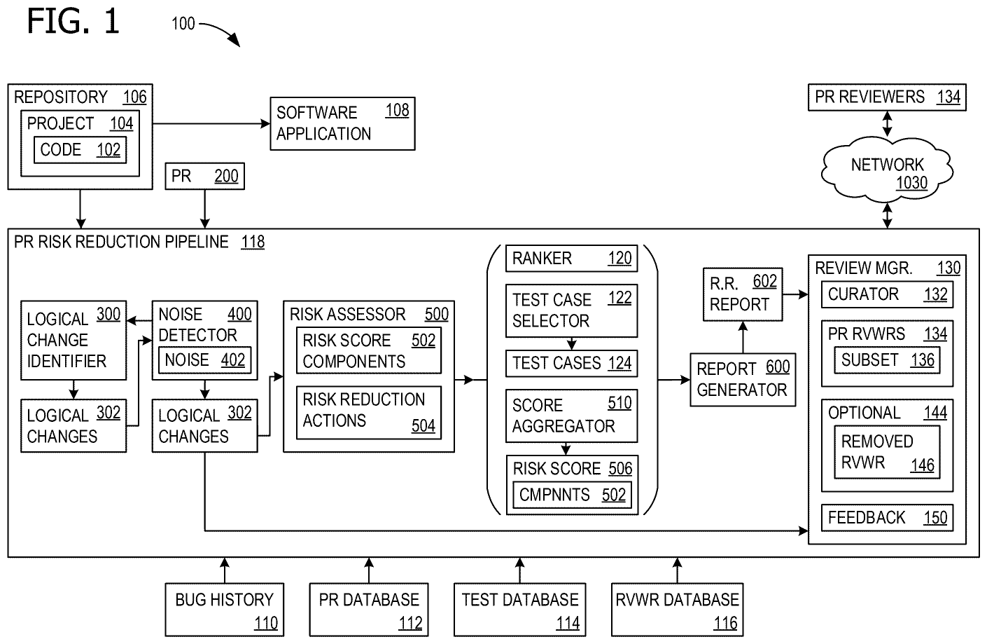

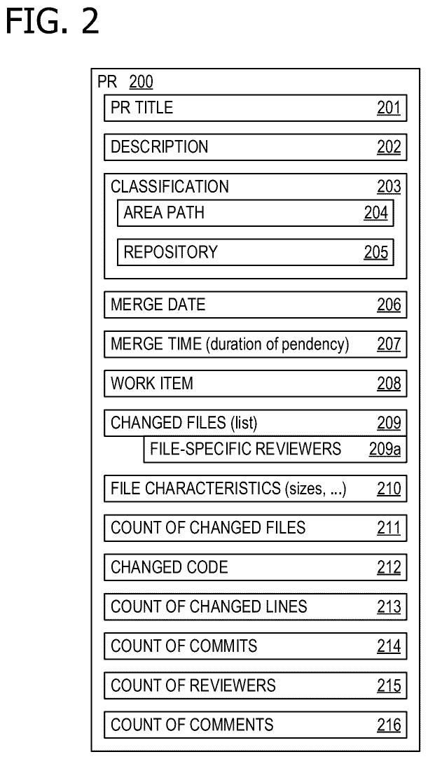

FIG. 1 illustrates an example architecture 100 that advantageously provides PR risk assessments and risk reductions. A software application 108 is created using plurality of PRs of a software code project 104, and distributed to users. The examples described herein are for a stage of that process involving a PR 200. An example of PR 200 is shown in FIG. 2, which is described below. Software code project 104 is stored in a code repository 106 and includes software code 102 that has changes (e.g., added functionality, bug fixes), and PR 200 is used to ensure the quality of the changes of software code 102, so that software code 102 can be merged into the main branch of the code for software code project 104 in code repository 106.

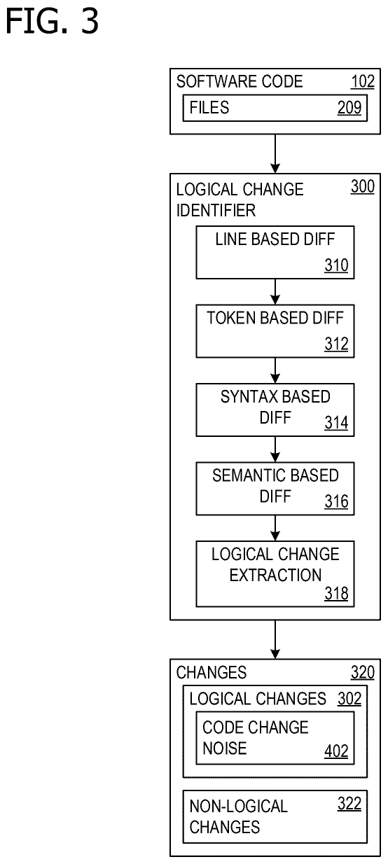

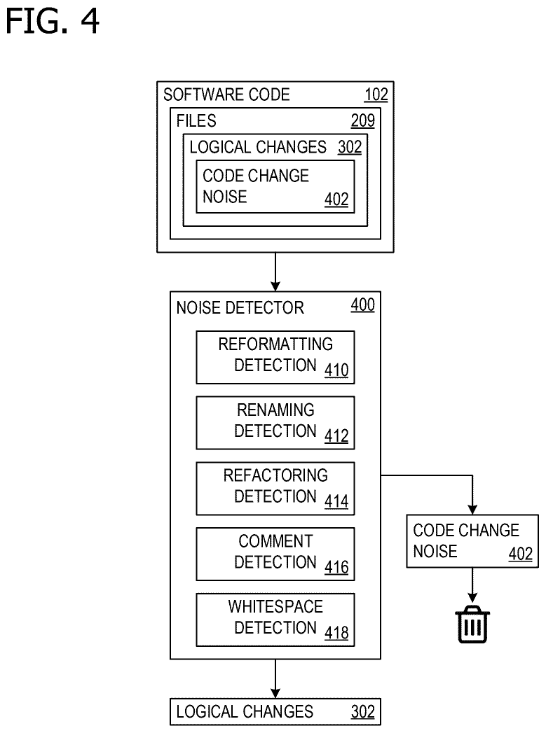

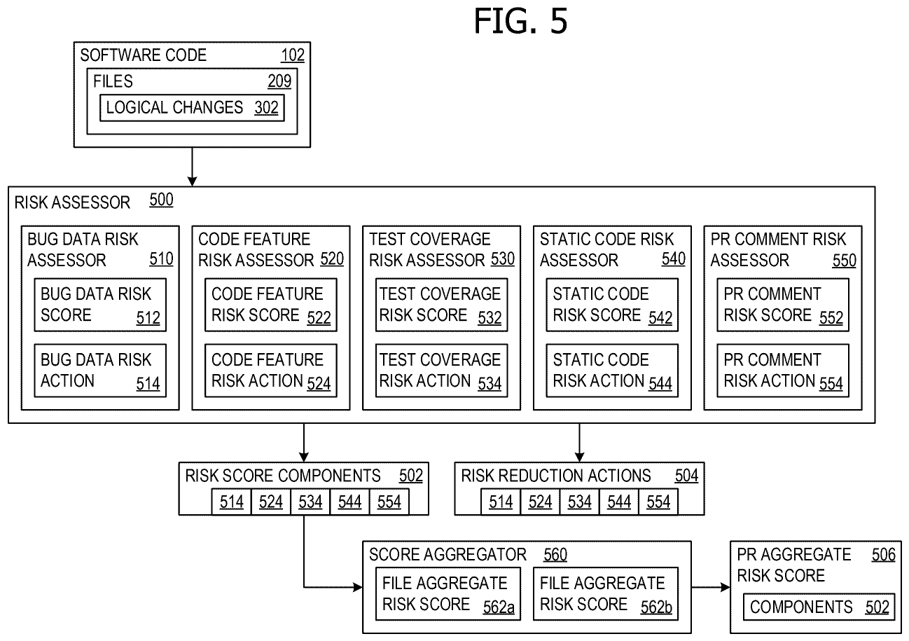

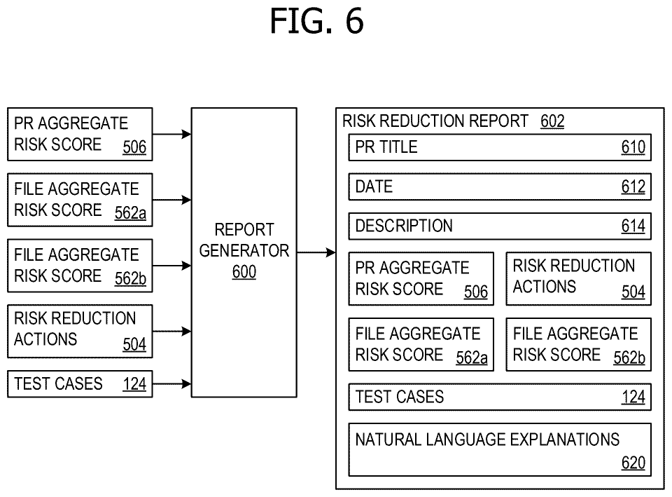

PR 200 and software code 102 are provided to a PR risk reduction pipeline 118 that has a logical change identifier 300, a noise detector 400, a risk assessor 500, a score aggregator 560, a test case selector 122, a report generator 600, and a review manager 130. Logical change identifier 300 is shown in further detail in FIG. 3, noise detector 400 is shown in further detail in FIG. 4, risk assessor 500 and score aggregator 560 are shown in further detail in FIG. 5, and report generator 600 is shown in further detail in FIG. 6. PR risk reduction pipeline 118 performs risk assessments and risk reductions for PRs, such as PR 200, and uses several datasets in support of this functionality. The datasets include a bug history 110, a PR database 112, a test database 114, a reviewer group database 116, and code repository 106.

Bug history 110, contains information about bugs that are reported or resolved in code repository 106. This may include a bug title, description, reproduction steps, severity, status, and the linked PRs that were created to fix the bug. This information may include linked manual test cases in test database 114 that are associated with the bugs, and/or which are created by code testers when failures are identified. Bug history 110 may be accessed and queried by risk assessor 500 to compare logical changes 302 (identified by logical change identifier 300) with the linked PRs of bug history 110 in order to determine a bug data risk score 512, as described in further detail in relation to FIG. 5.

PR database 112 is a storage location for PRs, PR summaries, area paths, merge dates, repositories, and prior PR risk scores. PR database 112 may use any suitable data structure and format, such as a relational database, a document database, a graph database, or a JSON file, to store and organize the PR data. PR database 112, contains information about previous PRs for software code project 104 in code repository 106 and other relevant software code projects. The information includes files, methods, and logical changes that are modified, added, or deleted by the PRs, and the comments that are provided by the reviewers of the logical changes. The information may also include summarizations of comments and the intent of prior risk remediation actions suggested by the reviewers of the logical changes, and which may be generated using natural language processing and artificial intelligence (AI) techniques. PR database 112 may be accessed and queried by risk assessor 500 to compare logical changes 302 with the prior PRs in order to determine a code feature risk score 522 and/or a static code risk score 542, as described in further detail in relation to FIG. 5.

Test database 114 contains information about the test coverage of code repository 106, including the test cases, test results, test metrics, and test reports that are generated and updated by the testing tools and frameworks that are used in code repository 106. Test database 114 may be accessed and queried by risk assessor 500 to compare the planned test coverage of logical changes 302 with the test coverage of the main branch of code repository 106 to assign a test coverage risk score 532, as described in further detail in relation to FIG. 5.

Reviewer group database 116 contains information about the reviewer groups that are involved in the PR review process, including the names, roles, expertise, and responsibilities of the reviewers, and the packages, folders, files, or features that they are owning or monitoring. Reviewer group database 116 may be accessed and queried by a reviewer group curator 132 to match logical changes 302 and their associated risk scores (or risk score components) with various potential reviewers' roles to select and prioritize which reviewers should be included in a set of PR reviewers 134 from which feedback is considered mandatory, and which potential reviewers may be moved into a set of optional PR reviewers 144.

Code repository 106 contains the original code of software code project 104 and the PRs that are submitted to modify it. Code repository 106 also stores the metadata and history of software code 102 and the PRs, such as the author, date, message, issue, or rationale of the PRs. Code repository 106 further stores static code analysis results and code formatter or style checker results, which are generated using static code analysis tools and code formatter or style checker tools. Code repository 106 may be accessed and compared by logical change identifier 300 and risk assessor 500 to identify logical changes 302 and risk score components 502, as described below.

Logical change identifier 300 identifies set of logical changes 302 in software code 102 using AI (or machine learning, ML, used synonymously herein). A logical change is one that affects the functionality, behavior, performance, or correctness of software code 102, and not just its style, appearance, structure, format, or documentation (e.g., comments). Noise detector 400 identifies and removes code change noise 402 from set of logical changes 302. In some examples, detection and removal of code change noise 402 from set of logical changes 302 is an iterative process in which set of logical changes 302 is successively refined as code change noise 402 is removed, until either no code change noise 402 remains, or is below some level.

Risk assessor 500 determines risk score components 502 and risk reduction actions 504 to take for set of logical changes 302 in software code 102 in order to remediate risk for PR 200. A risk ranker 120 ranks risk reduction actions 504 for a risk reduction report 602 that is supplied to set of PR reviewers 134, in order to assist in focusing the efforts of set of PR reviewers 134. Risk reduction actions 504 may be ranked based on their importance, relevance, and feasibility. Risk ranker 120 may use a weighting or a ranking scheme such as PageRank, to assign weights to risk reduction actions 504 based on their impact, frequency, and difficulty. Risk ranker 120 may use a filtering or a clustering technique, such as k-means, to group risk reduction actions 504 based on their similarity, priority, or category. Risk ranker 120 outputs a ranked version of risk reduction actions 504 for each logical change of set of logical changes 302, to show the most important, relevant, and feasible actions first. This improves efficiency in the review of PR 200.

Test case selector 122 selects test cases 124 from test database 114 to include as further suggested risk remediation in risk reduction report 602, which may be performed to verify the functionality and quality of set of logical changes 302. Test case selector 122 may use a test case selection technique such as coverage-based or similarity-based, to select test cases 124 that cover or are similar to set of logical changes 302. Test case selector 122 may also use a test case prioritization technique, such as risk-based or fault-based, to prioritize the test cases that are related to the high-risk or high-fault logical changes. Test case selector 122 outputs a selected and prioritized list of test cases for each logical change, showing the most relevant and important ones first.

A score aggregator 560 aggregates risk score components 502 into a PR aggregate risk score 506 for inclusion in risk reduction report 602. A report generator 600 may use generative AI to produce risk reduction report 602 and natural language explanations for the various portions identified thus far and factors of those portions.

A review manager 130 queries reviewer group database 116 and uses reviewer group curator 132 to curate set of PR reviewers 134, so that potential reviewers whose input is not mandatory (e.g., because those potential reviewers are not stakeholders in files having logical changes with relatively high risk) may be moved to set of optional PR reviewers 144. Reviewer group curator 132 is able to automatically assign the appropriate reviewer groups to PR 200 based on set of logical changes 302 and risk score components 502. In some examples, certain versions of risk reduction report 602 are sent to only a subset 136 of set of PR reviewers 134, based on riskiness of logical changes affecting that subset 136. For example, reviewer group curator 132 is also able to match set of logical changes 302 and their corresponding risk score components 502 with particular reviewers to select for subset 136.

An example of a removed PR reviewer 146, who is a stakeholder in a file of software code 102 that does not have a logical change, is shown as having been moved into set of optional PR reviewers 144, so that removed PR reviewer 146 is not distracted for other, potentially more significant work focus. This matches a narrower set of reviewers that are most relevant or important to review PR 200, improving the efficiency and effectiveness of the PR review process by reducing the noise, redundancy, and delay in the reviewer group selection and approval.

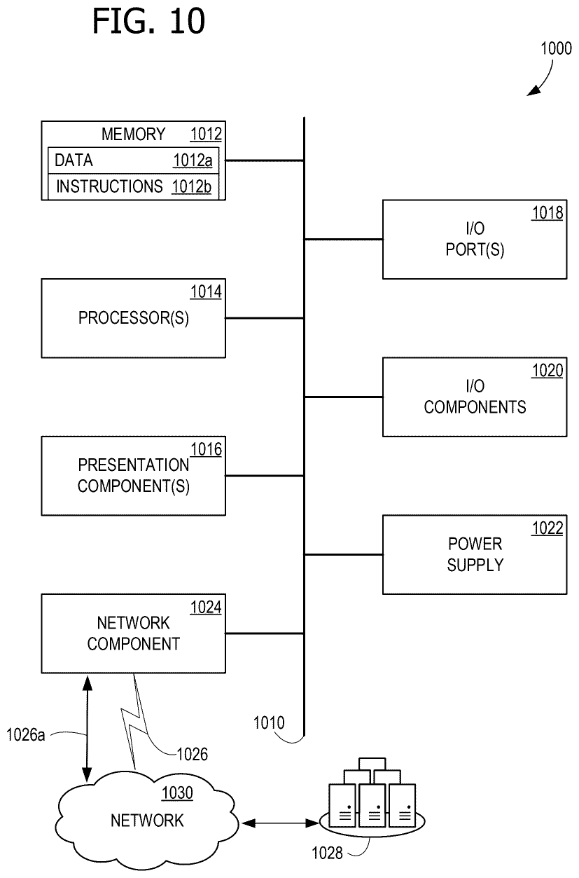

Review manager 130 transmits risk reduction report 602 across a computer network 1030 (shown in further detail in FIG. 10) to set of PR reviewers 134, who provide feedback 150. Review manager 130 displays the reviewer groups and their status to the developers and reviewers of PR 200, and notify them of the changes and the actions that are required or recommended. Feedback 150 is collected from set of PR reviewers 134 and includes comments, ratings, and/or suggestions, and is used to improve software code 102, reducing risk for PR 200, until PR 200 is ready for approval. In some examples, feedback 150 may include comments on risk scores being set too high or too low, or logical changes being missed or misidentified, and other observations by skilled human reviewers of the AI-generated results of PR risk reduction pipeline 118. In such scenarios, feedback 150 may further be used in additional training to improve the various AI/Ml components of PR risk reduction pipeline 118, such as adjusting the parameters, weights, or thresholds of risk calculations and the logical change identifications to enhance accuracy and performance.

FIG. 2 illustrates further detail for PR 200. PR 200 has a PR title 201, a PR description 202, a classification 203 that includes an area path 204 and/or a repository 205, a merge date 206, a merge time 207 (e.g., a period of pendency of the PR, indicating a slow or rushed process), an indication of a work item 208, an indication of files 209 of PR 200 (i.e., files of software code 102 that are changed with PR 200), file characteristics 210 (e.g., file size, file complexity, churn, and file ownership), a count of affected files 211, an indication of changed code 212, a count of lines of code 213, a count of commits 214, a count of reviewers 215, and a count of comments 216. An area path is a hierarchical classification of a work item by its functional or logical group which usually belongs to different owning teams (stakeholders). Some PRs may have additional or less content.

An identification of file-specific reviewers 209a is metadata for files 209 of PR 200, indicating entities (i.e., persons, groups, etc.) that are stakeholders in files 209 of PR 200 and thus are to be notified when any of files 209 of PR 200 are changed. Historically, all entities indicated in identification of file-specific reviewers 209a have been included in set of PR reviewers 134. However, this bloats set of PR reviewers 134, lengthening the PR review timeline. Using set of logical changes 302 as an input, for files 209 of PR 200 that do not have logical changes, the stakeholders for those files may be trimmed from set of PR reviewers 134 (at least the mandatory set), simplifying the PR review cycle.

FIG. 3 illustrates further detail for logical change identifier 300. Logical change identifier 300 identifies set of logical changes 302 within software code 102, specifically within files 209 of PR 200. Of a total set of changes 320, logical change identifier 300 is able to differentiate between logical changes (which are in set of logical changes 302) and non-logical changes 322, which affect presentation style, such as formatting, and comments, and other non-functional changes. Initially, set of logical changes 302 may have code change noise 402, which is removed as described below, in the explanation of FIG. 4.

Logical change identifier 300 applies one or more differences (diff) algorithms to software code 102 to detect differences from the version of the software code from which software code 102 is branched for modification. This may take the form of a hybrid diff algorithm that combines the results of different diff algorithms, each with its own advantages. Examples include a line-based diff algorithm 310, a token-based diff algorithm 312, a syntax-based diff algorithm 314, a semantic-based diff algorithm 316, and a logical change extraction algorithm 318.

Line-based diff algorithm 310 compares files 209 of PR 200 with those of the original software code at the line level and produces a line-based diff output that shows the added, deleted, or modified lines of code. Token-based diff algorithm parses the line-based diff output into tokens, such as keywords, identifiers, literals, operators, or symbols, and produces a token-based diff output that shows the added, deleted, or modified tokens in the PR. Syntax-based diff algorithm 314 constructs abstract syntax trees (ASTs) from the token-based diff output and produces a syntax-based diff output that shows the added, deleted, or modified AST nodes in PR 200. The AST nodes can represent the syntactic elements of software code 102, such as statements, expressions, variables, types, or functions.

Semantic-based diff algorithm 316 analyzes the semantic meaning and the context of the AST nodes and produces a semantic-based diff output that shows the added, deleted, or modified semantic units. The semantic units can represent the semantic elements of the code, such as control flow, data flow, variable scope, type inference, exception handling, or function calls. Logical change extraction algorithm 318 groups the semantic units into logical changes, which are coherent and meaningful units of code modification that affect the functionality or behavior of the code. A logical change can consist of one or more semantic units that are related by a common purpose, intention, or functionality. A logical change can also be annotated with metadata, such as the author, date, message, or rationale of the change. The set of these is set of logical changes 302.

FIG. 4 illustrates further detail for noise detector 400. Noise detector 400 is able to identify and remove code change noise 402 within logical changes 302 of files 209, and which may include formatting, renaming, refactoring, comments, and/or whitespace changes that do not affect the logic or functionality of software code 102. Noise detector 400 performs several tasks in support of this functionality, such as a reformatting detection task 410, a renaming detection task 412, a refactoring detection task 414, a comment detection task 416, and a whitespace detection task 418. Noise detector 400 may use multiple AI models, each trained specifically for one of the identified tasks, although some examples may be able to perform multiple tasks with a single AI model.

Reformatting detection task 410 detects formatting changes from PR 200, such as indentation, alignment, spacing, or punctuation that do not affect the syntax or the semantics of the code. The formatting detection may use a code formatter or a code style checker to identify and remove the formatting changes. Renaming detection task 412 detects renaming changes in files 209 of PR 200, such as file or variable renames, that do not affect the functionality or the behavior of software code 102. The renaming detector can use a code similarity or a code clone detection technique to identify and remove the renaming changes.

Refactoring detection task 414 detects refactoring changes from PR 200, such as method extraction, method in-lining, method moving, or variable extraction, that do not affect the functionality or the behavior of software code 102. The refactoring detection may use a code analysis or a code transformation technique to identify and remove the refactoring changes. Comment detection task 416 detects comment changes from files 209 of PR 200, such as adding, deleting, or modifying comments that do not affect the functionality or the behavior of software code 102. The comment detection may use natural language processing or a semantic analysis technique to identify and remove the comment changes. Whitespace detection task 418 detects whitespace changes from files 209 of PR 200, such as adding, deleting, or modifying blank lines, tabs, or spaces that do not affect the functionality or the behavior of software code 102. The whitespace detection may use a regular expression or a string comparison technique to identify and remove the whitespace changes.

FIG. 5 illustrates further detail for risk assessor 500. Risk assessor 500 receives set of logical changes 302 in files 209 of software code 102, with code change noise 402 having been removed. A bug data risk assessor 510 of risk assessor 500, which may be an AI model, queries bug history 110 to compare logical changes 302 with the linked PRs of bug history 110 in order to determine bug data risk score 512. A bug data risk reduction action 514 (one or more of them) is identified based on bug data risk score 512, and test cases related to bug data risk may be added to test cases 124.

A code feature risk assessor 520 of risk assessor 500, which may be an AI model, queries PR database 112 to compare logical changes 302 with the linked PRs in order to determine code feature risk score 522. A code feature risk reduction action 524 (one or more of them) is identified based on code feature risk score 522, and test cases related to code feature risk may be added to test cases 124. A test coverage risk assessor 530 of risk assessor 500, which may be an AI model, queries test database 114 to compare the planned test coverage of logical changes 302 with the test coverage of the main branch of code repository 106 to assign a test coverage risk score 532. A test coverage risk reduction action 534 (one or more of them) is identified based on test coverage risk score 532, and test cases identified as missing or needed may be added to test cases 124.

A static code risk assessor 540 of risk assessor 500, which may be an AI model, uses one or more static code analysis tools to assign a static code risk score 542. A static code risk reduction action 544 (one or more of them) is identified based on static code risk score 542, and test cases related to static code risk may be added to test cases 124. A PR comment risk assessor 550 of risk assessor 500, which may be an AI model, assigns a PR comment risk score 552. A PR comment risk reduction action 554 (one or more of them) is identified based on PR comment risk score 552, and test cases related to PR comment risk may be added to test cases 124.

Risk score components 502, which include bug data risk score 512, code feature risk score 522, test coverage risk score 532, static code risk score 542, and PR comment risk score 552 may each comprise a numerical value that reflects the probability of introducing a bug. Risk reduction actions 504, which include bug data risk reduction action 514, code feature risk reduction action 524, test coverage risk reduction action 534, static code risk reduction action 544, and PR comment risk reduction action 554 are each designed to reduce a respective one of bug data risk score 512, code feature risk score 522, test coverage risk score 532, static code risk score 542, and PR comment risk score 552.

Score aggregator 560 aggregates risk score components 502 first by each file of files 209, and then for PR 200 into PR aggregate risk score 506. A file aggregate risk score 562a and a file aggregate risk score 562b are shown to represent two files of files 209.

FIG. 6 illustrates further detail for report generator 600 and risk reduction report 602. In some examples, risk reduction report 602 has a PR title 610, a date 612, and a description 614 of PR 200, in addition to PR aggregate risk score 506, file aggregate risk scores 562a and 562b, risk reduction actions 504, and test cases 124. Report generator 600 may include a generative AI model that generates natural language explanations 620 for the factors affecting PR aggregate risk score 506, file aggregate risk scores 562a and 562b, risk reduction actions 504, and/or test cases 124.

Report generator 600 produces risk reduction report 602 to presentation suggestions and recommendations (e.g., risk reduction actions 504), and test cases 124 to the developers and reviewers of PR 200 (e.g., set of PR reviewers 134) in a clear, concise, and actionable manner. Natural language generation, such as template-based or neural-based, may be used to generate natural language sentences or paragraphs that explain the suggestions, recommendations, and identify the various test cases. Some examples may also use visualization presentations, such as charts or graphs, to provide a visualization of PR aggregate risk score 506, file aggregate risk scores 562a and 562b, and risk reduction actions 504. Risk reduction actions 504 and risk score components 502 may be identified according to each logical change of set of logical changes 302. Links (such as hyperlinks) may be provided as references to the sources of data, such as bug history 110, PR database 112, test database 114, code repository 106, and tools (e.g., the static code analysis tool), to provide support for risk reduction actions 504 and test cases 124.

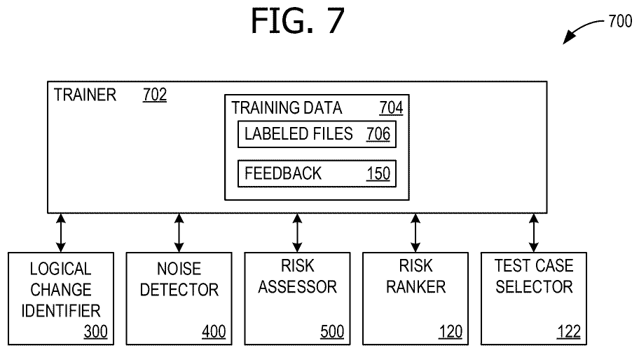

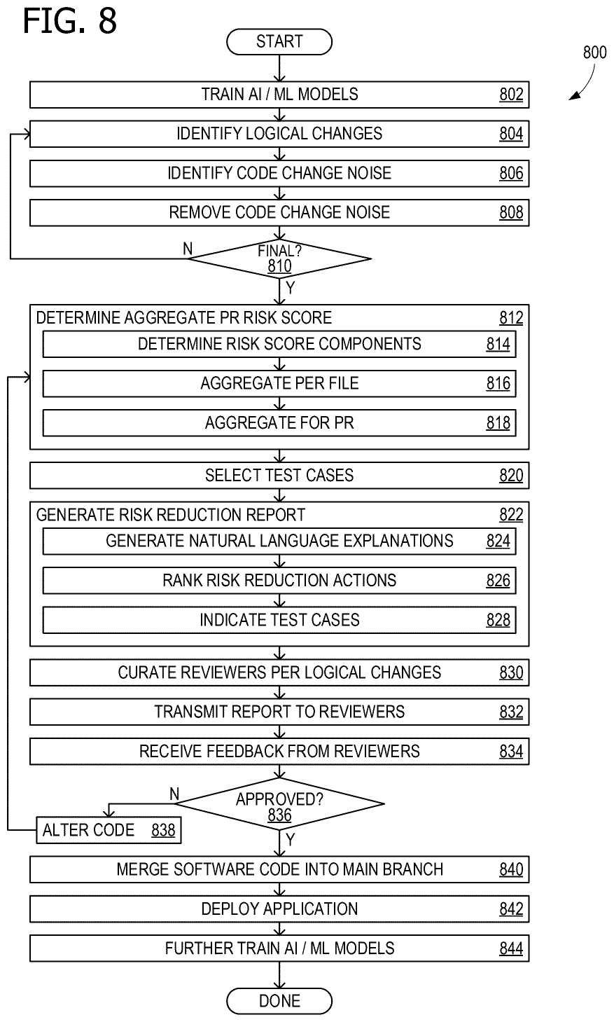

FIG. 7 illustrates an exemplary training arrangement 700 for components of architecture 100. In some examples, each of logical change identifier 300, noise detector 400, risk assessor 500, risk ranker 120, and training test case selector 122 comprise one or more AI models (or ML models). A trainer 702 has training data 704 that includes labeled files 706 and feedback 150. Training is described in relation to FIG. 8.

FIG. 8 shows a flowchart 800 illustrating exemplary operations that may be performed by architecture 100. In some examples, operations described for flowchart 800 are performed by computing device 1000 of FIG. 10. Flowchart 800 commences with training various AI (ML) powered components of architecture 100 in operation 802. This may include any of training logical change identifier 300 to differentiate between logical changes and non-logical changes in software code (e.g., set of logical changes 302 and non-logical changes 322 in software code 102), training noise detector 400 to identify code change noise (e.g., code change noise 402), training risk assessor 500 to determine risk score components for logical changes in software code (e.g., risk score components 502 for the logical changes in software code 102), training risk ranker 120 to rank risk reduction actions (e.g., risk reduction actions 504), and training test case selector 122 to select test cases (e.g., test cases 124).

Operations 804-808 loop until decision operation 810 determines that set of logical changes 302 are sufficiently finalized to proceed with risk analysis. Operation 804 identifies set of logical changes 302 within software code 102 of PR 200. This may include performing any or all of line-based diff algorithm 310, token-based diff algorithm 312, syntax-based diff algorithm 314, semantic-based diff algorithm 316, and logical change extraction algorithm 318.

Operation 806 identifies code change noise 402 within set of logical changes 302, and operation 808 removes code change noise 402 from set of logical changes 302. In some examples, identifying code change noise 402 comprises performing a noise detection task such as reformatting detection, renaming detection, refactoring detection, comment detection, and whitespace detection. After noise removal, flowchart 800 may return to operation 804, and this cycle may continue until code change noise 402 is sufficiently small that set of logical changes 302 is finalized for risk analysis.

Moving on, operations 812-838 may be looped for risk analysis and reduction until PR 200 is approved in decision operation 836. Operation 812 may be performed using operations 814-818 to determine PR aggregate risk score 506 for set of logical changes 302. Operation 814 determines risk score components such as bug data risk score 512, code feature risk score 522, test coverage risk score 532, static code risk score 542, and PR comment risk score 552 for each of files 209 of PR 200 having a logical change. Risk score components 502 are aggregated for each file into file aggregate risk scores, such as file aggregate risk scores 562a and 562b, in operation 816. Then, these file aggregate risk scores are aggregated into PR aggregate risk score 506 in operation 818, and operation 820 selects test cases 124 for software code 102 of PR 200 using bug history 110.

Risk reduction report 602 is generated in operation 822 using operations 824-828. Operation 824 generates natural language explanations 620 for the factors affecting PR aggregate risk score 506, risk reduction actions 504, and recommended test cases (e.g., test cases 124). Operation 826 ranks risk reduction actions 504, within risk reduction report 602, according to priority, and operation 828 indicates PR aggregate risk score 506, file aggregate risk scores 562a and 562b (color-coded according to risk, in some examples), and test cases 124 for software code 102 of PR 200, within risk reduction report 602.

Set of PR reviewers 134 is curated based on at least identifying set of logical changes 302 and non-logical changes 322 in software code 102 of PR 200, in operation 830. In some examples, this includes selecting, for each file of PR 200 having a logical change, subset 136 of set of PR reviewers 134, based on at least file aggregate risk score 562a or 562b and identification of file-specific reviewers 209a. In some examples, curating set of PR reviewers 134 comprises removing, from set of PR reviewers 134, removed PR reviewer 146, who is associated with only non-logical changes 322 and/or is not associated with set of logical changes 302. This may include moving removed PR reviewer 146 to set of optional PR reviewers 144.

Operation 832 transmits risk reduction report 602 across computer network 1030 to at least a portion of (newly-curated) set of PR reviewers 134, and feedback 150 relating to risk reduction report 602 is received from at least a portion of set of PR reviewers 134 in operation 834. If decision operation 836 determines that PR 200 is approved, flowchart 800 moves on to operation 840. Otherwise, operation 838 performs the risk reduction by altering software code 102 of PR 200 in accordance with risk reduction actions 504 identified within risk reduction report 602. In some examples, this may be performed automatically or semi-automatically, using ML code completion tools. Flowchart 800 then returns to operation 812.

When PR 200 is approved, software code 102 of PR 200 is merged into software code project 104 in operation 840, based on at least altering software code 102 of PR 200 in accordance with risk reduction actions 504 (in operation 838).

Software application 108 (which is now based on at least software code 102 being merged into software code project 104) is deployed in operation 842. Operation 844 performs further training on AI powered components of architecture 100 using feedback 150. For example, logical change identifier 300 is trained further to differentiate between logical changes and non-logical changes in software code, and risk assessor 500 is further trained to determine risk score components.

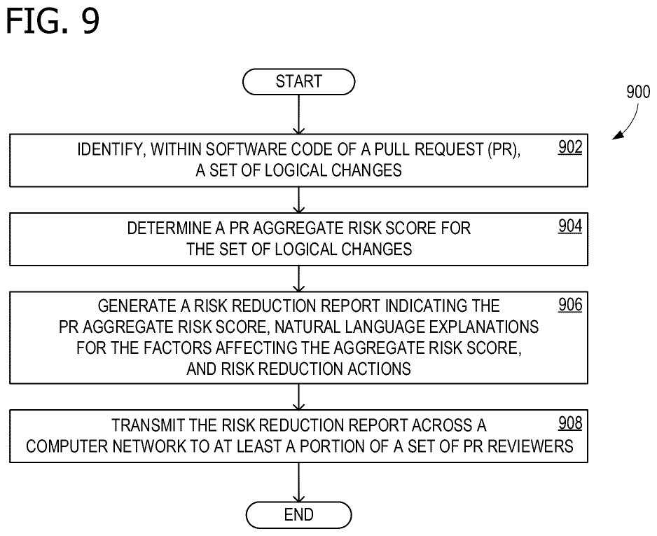

FIG. 9 shows a flowchart 900 illustrating exemplary operations that may be performed by architecture 100. In some examples, operations described for flowchart 900 are performed by computing device 1000 of FIG. 10. Flowchart 900 commences with operation 902, which includes identifying, within software code of a PR, a set of logical changes. Operation 904 includes determining a PR aggregate risk score for the set of logical changes. Operation 906 includes generating a risk reduction report indicating the PR aggregate risk score, natural language explanations for factors affecting the PR aggregate risk score, and risk reduction actions. Operation 908 includes transmitting the risk reduction report across a computer network to at least a portion of a set of PR reviewers.

### Additional Examples

An example system comprises: a processor; and a computer-readable medium storing instructions that are operative upon execution by the processor to: identify, within software code of a PR, a set of logical changes; determine a PR aggregate risk score for the set of logical changes; generate a risk reduction report indicating the PR aggregate risk score, natural language explanations for factors affecting the PR aggregate risk score, and risk reduction actions; and transmit the risk reduction report across a computer network to at least a portion of a set of PR reviewers.

An example computer-implemented method comprises: identifying, within software code of a PR, a set of logical changes; determining a PR aggregate risk score for the set of logical changes; generating a risk reduction report indicating the PR aggregate risk score, natural language explanations for factors affecting the PR aggregate risk score, and risk reduction actions; and transmitting the risk reduction report across a computer network to at least a portion of a set of PR reviewers.

One or more example computer storage devices have computer-executable instructions stored thereon, which, on execution by a computer, cause the computer to perform operations comprising: identifying, within software code of a PR, a set of logical changes; identifying, within the set of logical changes, code change noise; removing, from the set of logical changes, the code change noise; determining a PR aggregate risk score for the set of logical changes; generating a risk reduction report indicating the PR aggregate risk score, natural language explanations for factors affecting the PR aggregate risk score, and risk reduction actions; transmitting the risk reduction report across a computer network to at least a portion of a set of PR reviewers; altering the software code of the PR in accordance with the risk reduction actions identified within the risk reduction report; and based on at least altering the software code of the PR in accordance with the risk reduction actions, merging the software code of the PR into a software code project.

Alternatively, or in addition to the other examples described herein, examples include any combination of the following:
altering the software code of the PR in accordance with the risk reduction actions identified within the risk reduction report;
based on at least altering the software code of the PR in accordance with the risk reduction actions, merging the software code of the PR into a software code project;
identifying, within the set of logical changes, code change noise;
removing, from the set of logical changes, the code change noise;
identifying the code change noise comprises performing a noise detection task selected from the set of tasks consisting of: reformatting detection, renaming detection, refactoring detection, comment detection, and whitespace detection;
identifying the set of logical changes comprises performing a diff algorithm selected from the set of algorithms consisting of: a line-based diff, a token-based diff, a syntax-based diff, a semantic-based diff, and a logical change extraction;
determining the PR aggregate risk score comprises determining two or more risk score components from the set of risk score components consisting of: a bug data risk score, a code feature risk score, a test coverage risk score, a static code risk score, and a PR comment risk score;
aggregating the determined risk score components into the PR aggregate risk score;
for each file of the PR having a logical change, determining two or more risk score components from the set of risk score components;
aggregating, for each file, the determined risk score components into a file aggregate risk score;
aggregating the file aggregate risk scores into the PR aggregate risk score;
selecting, for each file of the PR having a logical change, a subset of the set of PR reviewers, based on at least the file aggregate risk score and an identification of file-specific reviewers;
ranking, within the risk reduction report, the risk reduction actions according to priority;
indicating, within the risk reduction report, test cases for the software code of the PR;
receiving, from at least a portion of the set of PR reviewers, feedback relating to the risk reduction report;
further training a logical change identifier to differentiate between logical changes and non-logical changes in software code;
further training a risk assessor to determine risk score components using the feedback;
training the logical change identifier to differentiate between logical changes and non-logical changes in software code;
the logical change identifier comprises an AI model;
training a noise detector to identify code change noise;
the noise detector comprises an AI model;
training the risk assessor to generate the risk score components for logical changes in software code;
the risk assessor comprises an AI model;
training the risk ranker to rank the risk reduction actions;
the risk ranker comprises an AI model;
training the test case selector to select test cases;
the test case selector comprises an AI model;
generating natural language explanations for factors affecting the PR aggregate risk score, the risk reduction actions, and recommended test cases;
selecting the test cases for the software code of the PR using a bug history;
based on at least identifying the set of logical changes and non-logical changes in the software code of the PR, curating the set of PR reviewers;
curating the set of PR reviewers comprises removing, from the set of PR reviewers, a PR reviewer associated with only a non-logical change or not associated with a logical change; and
moving the removed PR reviewer to a set of optional PR reviewers.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 10 is a block diagram of an example computing device 1000 (e.g., a computer storage device) for implementing aspects disclosed herein, and is designated generally as computing device 1000. In some examples, one or more computing devices 1000 are provided for an on-premises computing solution. In some examples, one or more computing devices 1000 are provided as a cloud computing solution. In some examples, a combination of on-premises and cloud computing solutions are used. Computing device 1000 is but one example of a suitable computing environment and is not intended to suggest any limitation as to the scope of use or functionality of the examples disclosed herein, whether used singly or as part of a larger set.

Neither should computing device 1000 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1000 includes a bus 1010 that directly or indirectly couples the following devices: computer storage memory 1012, one or more processors 1014, one or more presentation components 1016, input/output (I/O) ports 1018, I/O components 1020, a power supply 1022, and a network component 1024. While computing device 1000 is depicted as a seemingly single device, multiple computing devices 1000 may work together and share the depicted device resources. For example, memory 1012 may be distributed across multiple devices, and processor(s) 1014 may be housed with different devices.

Bus 1010 represents what may be one or more buses (such as an address bus, data bus, or a combination thereof). Although the various blocks of FIG. 10 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.” Memory 1012 may take the form of the computer storage media referenced below and operatively provide storage of computer-readable instructions, data structures, program modules and other data for the computing device 1000. In some examples, memory 1012 stores one or more of an operating system, a universal application platform, or other program modules and program data. Memory 1012 is thus able to store and access data 1012a and instructions 1012b that are executable by processor 1014 and configured to carry out the various operations disclosed herein. Thus, computing device 1000 comprises a computer storage device having computer-executable instructions 1012b stored thereon.

In some examples, memory 1012 includes computer storage media. Memory 1012 may include any quantity of memory associated with or accessible by the computing device 1000. Memory 1012 may be internal to the computing device 1000 (as shown in FIG. 10), external to the computing device 1000 (not shown), or both (not shown). Additionally, or alternatively, the memory 1012 may be distributed across multiple computing devices 1000, for example, in a virtualized environment in which instruction processing is carried out on multiple computing devices 1000. For the purposes of this disclosure, “computer storage media,” “computer storage memory,” “memory,” and “memory devices” are synonymous terms for the memory 1012, and none of these terms include carrier waves or propagating signaling.

Processor(s) 1014 may include any quantity of processing units that read data from various entities, such as memory 1012 or I/O components 1020. Specifically, processor(s) 1014 are programmed to execute computer-executable instructions for implementing aspects of the disclosure. The instructions may be performed by the processor, by multiple processors within the computing device 1000, or by a processor external to the client computing device 1000. In some examples, the processor(s) 1014 are programmed to execute instructions such as those illustrated in the flow charts discussed below and depicted in the accompanying drawings. Moreover, in some examples, the processor(s) 1014 represents an implementation of analog techniques to perform the operations described herein. For example, the operations may be performed by an analog client computing device 1000 and/or a digital client computing device 1000. Presentation component(s) 1016 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1000, across a wired connection, or in other ways. I/O ports 1018 allow computing device 1000 to be logically coupled to other devices including I/O components 1020, some of which may be built in. Example I/O components 1020 include, for example but without limitation, a microphone, joystick, game pad, satellite dish, scanner, printer, wireless device, etc.

Computing device 1000 may operate in a networked environment via the network component 1024 using logical connections to one or more remote computers. In some examples, the network component 1024 includes a network interface card and/or computer-executable instructions (e.g., a driver) for operating the network interface card. Communication between the computing device 1000 and other devices may occur using any protocol or mechanism over any wired or wireless connection. In some examples, network component 1024 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1024 communicates over wireless communication link 1026 and/or a wired communication link 1026a to a remote resource 1028 (e.g., a cloud resource) across computer network 1030. Various different examples of communication links 1026 and 1026a include a wireless connection, a wired connection, and/or a dedicated link, and in some examples, at least a portion is routed through the internet.

Although described in connection with an example computing device 1000, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
identify, within software code of a pull request (PR), a set of logical changes;
determine a PR aggregate risk score for the set of logical changes;
generate a risk reduction report indicating the PR aggregate risk score, natural language explanations for factors affecting the PR aggregate risk score, and risk reduction actions; and
transmit the risk reduction report across a computer network to at least a portion of a set of PR reviewers.

2. The system of claim 1, wherein the instructions are further operative to:
alter the software code of the PR in accordance with the risk reduction actions identified within the risk reduction report; and
based on at least altering the software code of the PR in accordance with the risk reduction actions, merge the software code of the PR into a software code project.

3. The system of claim 1, wherein the instructions are further operative to:
identify, within the set of logical changes, code change noise, wherein identifying the code change noise comprises performing a noise detection task selected from the set of tasks consisting of:
reformatting detection, renaming detection, refactoring detection, comment detection, and whitespace detection; and
remove, from the set of logical changes, the code change noise.

4. The system of claim 1, wherein identifying the set of logical changes comprises performing a differences (diff) algorithm selected from the set of algorithms consisting of:
a line-based diff, a token-based diff, a syntax-based diff, a semantic-based diff, and a logical change extraction.

5. The system of claim 1, wherein determining the PR aggregate risk score comprises determining two or more risk score components from the set of risk score components consisting of:
a bug data risk score, a code feature risk score, a test coverage risk score, a static code risk score, and a PR comment risk score; and
wherein the instructions are further operative to:
aggregate the determined risk score components into the PR aggregate risk score.

6. The system of claim 5, wherein the instructions are further operative to:
for each file of the PR having a logical change, generate two or more risk score components from the set of risk score components; and
aggregate, for each file, the determined risk score components into a file aggregate risk score; and
aggregate the file aggregate risk scores into the PR aggregate risk score.

7. The system of claim 1, wherein the instructions are further operative to:
rank, within the risk reduction report, the risk reduction actions according to priority; and
indicate, within the risk reduction report, test cases for the software code of the PR.

8. A computer-implemented method comprising:
identifying, within software code of a pull request (PR), a set of logical changes;
determining a PR aggregate risk score for the set of logical changes;
generating a risk reduction report indicating the PR aggregate risk score, natural language explanations for factors affecting the PR aggregate risk score, and risk reduction actions; and
transmitting the risk reduction report across a computer network to at least a portion of a set of PR reviewers.

9. The method of claim 8, further comprising:
altering the software code of the PR in accordance with the risk reduction actions identified within the risk reduction report; and
based on at least altering the software code of the PR in accordance with the risk reduction actions, merging the software code of the PR into a software code project.

10. The method of claim 8, further comprising:
identifying, within the set of logical changes, code change noise; and
removing, from the set of logical changes, the code change noise.

11. The method of claim 10, wherein identifying the code change noise comprises performing a noise detection task selected from the set of tasks consisting of:
reformatting detection, renaming detection, refactoring detection, comment detection, and whitespace detection.

12. The method of claim 8, wherein identifying the set of logical changes comprises performing a differences (diff) algorithm selected from the set of algorithms consisting of:
a line-based diff, a token-based diff, a syntax-based diff, a semantic-based diff, and a logical change extraction.

13. The method of claim 8, wherein determining the PR aggregate risk score comprises determining two or more risk score components from the set of risk score components consisting of:
a bug data risk score, a code feature risk score, a test coverage risk score, a static code risk score, and a PR comment risk score; and
wherein the method further comprises:
aggregating the determined risk score components into the PR aggregate risk score.

14. The method of claim 13, further comprising:
for each file of the PR having a logical change, determining two or more risk score components from the set of risk score components; and
aggregating, for each file, the determined risk score components into a file aggregate risk score; and
aggregating the file aggregate risk scores into the PR aggregate risk score.

15. The method of claim 14, further comprising:
selecting, for each file of the PR having a logical change, a subset of the set of PR reviewers, based on at least the file aggregate risk score and an identification of file-specific reviewers.

16. The method of claim 8, further comprising:
ranking, within the risk reduction report, the risk reduction actions according to priority; and
indicating, within the risk reduction report, test cases for the software code of the PR.

17. The method of claim 8, further comprising:
receiving, from at least a portion of the set of PR reviewers, feedback relating to the risk reduction report; and
further training a logical change identifier to differentiate between logical changes and non-logical changes in software code and/or a risk assessor to determine risk score components using the feedback.

18. A computer storage device having computer-executable instructions stored thereon, which, on execution by a computer, cause the computer to perform operations comprising:
identifying, within software code of a pull request (PR), a set of logical changes;
identifying, within the set of logical changes, code change noise;
removing, from the set of logical changes, the code change noise;
determining a PR aggregate risk score for the set of logical changes;
generating a risk reduction report indicating the PR aggregate risk score, natural language explanations for factors affecting the PR aggregate risk score, and risk reduction actions;
transmitting the risk reduction report across a computer network to at least a portion of a set of PR reviewers;
altering the software code of the PR in accordance with the risk reduction actions identified within the risk reduction report; and
based on at least altering the software code of the PR in accordance with the risk reduction actions, merging the software code of the PR into a software code project.

19. The computer storage device of claim 18,
wherein identifying the code change noise comprises performing a noise detection task selected from the set of tasks consisting of:
reformatting detection, renaming detection, refactoring detection, comment detection, and whitespace detection,
wherein identifying the set of logical changes comprises performing a differences (diff) algorithm selected from the set of algorithms consisting of:
a line-based diff, a token-based diff, a syntax-based diff, a semantic-based diff, and a logical change extraction,
wherein determining the PR aggregate risk score comprises determining two or more risk score components from the set of risk score components consisting of:
a bug data risk score, a code feature risk score, a test coverage risk score, a static code risk score, and a PR comment risk score; and
wherein the operations further comprise:
aggregating the determined risk score components into the PR aggregate risk score.

20. The computer storage device of claim 19, wherein the operations further comprise:
for each file of the PR having a logical change, determining two or more risk score components from the set of risk score components; and
aggregating, for each file, the determined risk score components into a file aggregate risk score; and
aggregating the file aggregate risk scores into the PR aggregate risk score.
